(19) United States
(12) Patent Application Publication
(10) Pub. No.: US 2004/0022495 A1
(43) Pub. Date: Feb. 5, 2004

(54) Directional integrated optical power monitor and optional hermetic feedthrough

(76) Inventors: Andrew P. Shapiro, Schenectady, NY (US); Kwok Pong Chan, Troy, NY (US); Paul R. Quantock, Stillwater, NY (US); David G. Gascoyne, Niskayuna, NY (US); Peter Case, East Greenbush, NY (US); Charles J. Mack, Nazareth, PA (US); Janet L. Krahn, Schenectady, NY (US); Thomas J. Oathout, Troy, NY (US)

Correspondence Address: HESLIN ROTHENBERG FARLEY & MESITI PC, 5 COLUMBIA CIRCLE, ALBANY, NY, 12203, US

(21) Appl. No.: 10/390,313

(22) Filed: Mar. 17, 2003

Related U.S. Application Data
(60) Provisional application No. 60/364,434, filed on Mar. 15, 2002.
(60) Provisional application No. 60/429,084, filed on Nov. 26, 2002.
(60) Provisional application No. 60/452,440, filed on Mar. 6, 2003.

(51) Int. Cl. G02B 6/26

(52) U.S. Cl. 385/48

(57) ABSTRACT

A directional integrated optical power monitor is disclosed. The power monitor includes an unbroken portion of a conventional optical fiber through which optical energy can propagate. The portion of optical fiber included in the power monitor has material removed from the cladding, generally by side polishing, to expose a side surface through which at least some of the optical energy leaks or can be extracted. A bulk material, such as a polymer or glass overlay, is positioned over the polished side surface of the fiber, and the bulk material has an index of refraction higher than the effective mode index of refraction of the fiber optic. A photodetector is positioned at the place of maximum optical signal strength to capture the extracted optical energy. The directional integrated optical power monitor can also be used in an assembly to provide a device that is hermetically sealed.

### CROSS-REFERENCE TO RELATED APPLICATIONS

This application claims the priority of U.S. Provisional Patent Application Serial No. 60/364,434, filed Mar. 15, 2002, U.S. Provisional Patent Application Serial No. 60/429,084, filed Nov. 26, 2002, and U.S. Provisional Patent Application entitled “Side-Polished Fiber in Metal Block”, filed Mar. 6, 2003 under Atty Dkt. No. 0953.104(P), the disclosures of which are incorporated herein by reference in their entireties.

This Application is related to the following U.S. Patent Applications/Patents:

Ser. No. 09/811,913, filed Mar. 19, 2001, entitled “VARIABLE OPTICAL ATTENUATOR EMPLOYING POLARIZATION MAINTAINING FIBER”, now U.S. Pat. No. ______ issued ______;

Ser. No. 09/812,097 filed Mar. 19, 2001, entitled “FIBER OTPIC POWER CONTROL SYSTEMS AND METHODS”, now U.S. Pat. No. ______ issued ______;

Ser. No. 09/605,110, filed Jun. 28, 2000, entitled “SINGLE CHANNEL ATTENUATORS”, now U.S. Pat. No. 6,483,981 issued Nov. 19, 2002;

Ser. No. 09/539,469, filed Mar. 30, 2000, entitled “CONTROLLABLE FIBER OPTIC ATTENUATORS EMPLOYING TAPERED AND/OR ETCHED FIBER SECTIONS”, now U.S. Pat. No. 6,466,729 issued Oct. 15, 2002;

Ser. No. 09/139,832, filed Aug. 25, 1998, entitled “BLOCKLESS TECHNIQUES FOR SIMULTANEOUS POLISHING OF MULTIPLE FIBER OPTICS”, now U.S. Pat. No. 6,374,011 issued Apr. 16, 2002;

Ser. No. 09/139,787, filed Aug. 25, 1998, entitled “BLOCKLESS FIBER OPTIC ATTENUATORS AND ATTENUATION SYSTEMS EMPLOYING DISPERSION TAILORED POLYMERS”, now U.S. Pat. No. 6,205,280 issued Mar. 20, 2001; and

Ser. No. 09/026,755, filed Feb. 20, 1998, entitled “FIBER OPTIC ATTENUATORS AND ATTENUATION SYSTEMS”, now U.S. Pat. No. 5,966,493 issued Oct. 12, 1999.

Each of these Applications and Patents is hereby incorporated by reference herein in its entirety.

### TECHNICAL FIELD

The present invention relates to monitoring the strength of optical signals passing through optical fibers, and more particularly to a directional integrated optical power monitor, optionally combined in a single assembly with a hermetically sealed feedthrough.

### BACKGROUND OF THE INVENTION

With the advance of fiber optical networks, there is an increasing need to monitor the strength of an optical signal within an optical network. Examples of optical power monitoring are found in broadband amplifiers, optical protection switches, and optical interface modules. The optical signal information can be used as a feedback signal in controlling optical components, such as lasers, tunable lasers, variable attenuators, optical amplifiers, such as erbium doped fiber amplifiers, modulators, and switches, to name a few.

Historically, optical monitoring has been done using a fused fiber coupler and a fiber coupled photodiode. In this configuration, as shown in FIG. 1, the fused fiber coupler is spliced into the optical fiber of interest, and a fiber-coupled photodiode is spliced to one of the outputs of the coupler. Disadvantageously, however, the fiber handling requirement of this design requires a substantial amount of valuable real estate on the system, which is then multiplied when an array of optical monitors is required. Thus, more compact optical power monitoring components were needed to avoid this problem.

In response thereto, compact optical power monitors based on micro-optics and thin film filters were recently introduced and remain currently available. One such device is depicted in FIG. 2. However, an important drawback with these devices is that they are non-directional due to back reflection through the fiber, and thus, cannot differentiate the direction of the optical signal, which is a major performance requirement. Another disadvantage is that due to breaks in the fiber, the excess loss of these devices is high compared to that of the aforementioned fused fiber coupler combined with a photodiode depicted in FIG. 1.

For the aforementioned reasons, there is a need for an optical power monitor, which retains all the advantages of the currently known devices without the shortcomings thereof. Such a monitor should be compact and directional and should exhibit low excess optical losses. In addition, the device should be cost effective and easy to manufacture. The directional integrated power monitor of the present invention, which is based on side-polished fiber technology, meets this need. The term “side-polished fiber” is also referred to herein as “SPF”.

Another feature, which makes the present optical power monitor attractive, is that it can be fabricated with or without the use of epoxies, oils, polymers, organic adhesives, or other organic bonding materials. In some applications, the use of these materials is undesirable because they alter the index of refraction of the monitor's components, and they can outgas, thereby contaminating other optical components of the monitor's components. For example, epoxies are not desired when the active components contain laser diodes.

Furthermore, it is advantageous to combine functions in single assemblies to reduce the cost and size of optoelectronic components. The present directional integrated power monitor meets this need when it is combined in a single assembly with a hermetically sealable fiber feedthrough.

### SUMMARY OF THE INVENTION

Accordingly, in one aspect, the present invention is a directional integrated optical power monitor. Included in the optical power monitor is an unbroken portion of an optical fiber through which optical energy can propagate, and the optical fiber has a core surrounded by a cladding. The portion of optical fiber has material removed from the cladding, thereby exposing a side surface through which at least some of the optical energy can be extracted, and the side surface terminates at a first end and a second end along the portion of optical fiber. A bulk material resides over the side surface, and the bulk material has an index of refraction higher than the effective mode index of refraction of the optical fiber. Also included in the power monitor is a photodetector to capture the extracted optical energy. The photodetector is positioned at the place of maximum optical signal strength, which is in close proximity to the first end or the second end of the side surface.

As used herein, the term “index of refraction” and “refractive index” are synonymous and interchangeable.

The bulk material is a polymer or a glass overlay, and the optical fiber is suspended or mounted on a support block comprising glass, Invar, Kovar, or a stainless steel alloy. Furthermore, the glass overlay may have a first and second metal bracket bonded thereto, wherein the first metal bracket is bonded to a first sidewall of the glass overlay, and the second metal bracket is bonded to a second sidewall of the glass overlay. The photodetector may be mounted to an end face of the glass overlay or to the support block. When the bulk material is a polymer, the photodetector may be placed in the polymer or mounted to the support block when one is used.

In another aspect, the present invention is an optical power monitor assembly comprising a directional integrated optical power monitor having a support block, as previously described, in combination with a hermetic feedthrough. The assembly comprises: a metal ferrule having a first end with a first opening, which opens into a first cavity in the ferrule, and having a second end with a second opening, which opens into a second cavity in the ferrule. The first cavity is in fluidic communication with the second cavity thereby forming a feedthrough hole, which extends from the first opening to the second opening. A metal platform extends from the first end of the metal ferrule and supports the directional integrated optical power monitor. A section of bare optical fiber extends from the portion of optical fiber of the integrated optical power monitor, and the bare optical fiber is free of a protective buffer material cover. The section of bare optical fiber enters the first cavity through the first opening of the ferrule, passing through the first cavity and into the second cavity. A section of optical fiber having the protective buffer material cover thereon extends from the bare optical fiber in the second cavity and exits the ferrule through the second opening. A glass solder material is disposed in the first opening and resides in the first cavity. The glass solder material adheres to and surrounds the bare optical fiber and adheres to an interior wall bordering the first cavity of the ferrule. A hermetic seal is formed at the first opening of the ferrule.

The present integrated optical power monitor may be used as a component in other optical devices, such as lasers, tunable lasers, variable attenuators, optical amplifiers, such as erbium doped fiber amplifiers, modulators, switches, etc. Furthermore, by combining the directional integrated optical power monitor with a hermetically sealed fiber feedthrough in a single assembly, cost savings and size reduction can be realized. In addition, the present device provides for the elimination of epoxies, polymers, or other adhesives if desired for a particular application.

### BRIEF DESCRIPTION OF THE DRAWING

The present invention may take form in various components and arrangements of components, and in various steps and arrangement of steps. The drawings presented herewith, wherein like reference numerals designate identical or corresponding parts throughout the several views, are for purposes of illustrating certain embodiments and should not be construed as limiting the invention. The subject matter, which is regarded as the invention, is particularly pointed out and distinctly claimed in the claims at the conclusion of the specification.

FIG. 1 is a side view of a prior art optical power monitor comprising a fused fiber coupler and a fiber coupled photodiode;

FIG. 2 is a side view of a prior art optical power monitor based on micro-optics and thin film filters;

FIG. 3A is a cross-sectional view of a directional integrated optical power monitor in accordance with the present invention wherein a polymer is the bulk material and the photodetector is positioned parallel to the optical fiber;

FIG. 3B is a cross-sectional view of a directional integrated optical power monitors in accordance with the present invention wherein a polymer is the bulk material and the photodetector is positioned perpendicular to the optical fiber;

FIG. 4B is a perspective view of an optical fiber embedded in a support block of solid material prior to side-polishing the fiber;

FIG. 4B is a cross-sectional view of an optical fiber and support block after the fiber has been side-polished;

FIG. 5 is a cross-sectional view of a directional integrated optical power monitor in accordance with the present invention, wherein a glass overlay is used as the bulk material on a support block;

FIG. 6 is a cross-sectional view of a directional integrated optical power monitor in accordance with the present invention, wherein a glass overlay is used as the bulk material and a metal is used as the support block;

FIG. 7 is a perspective view of the glass overlay used in the device of FIG. 6, wherein metal brackets are bonded to the glass;

FIG. 8 is a side view of an integrated optical power monitor assembly in accordance with the present invention, wherein a directional integrated optical power monitor is combined with a hermetic feedthrough;

FIG. 9 is a cross-sectional view of the ferrule and hermetic feedthrough used in the integrated optical power monitor assembly of FIG. 8; in accordance with the present invention;

FIG. 10 is a perspective view of an integrated optical power monitor assembly in accordance with the present invention, wherein the directional integrated optical power monitor component uses a polymer as the bulk material; and

FIG. 11 is a perspective view of an integrated optical power monitor assembly in accordance with the present invention, wherein the directional integrated optical power monitor component uses a glass overlay with metal brackets as the bulk material.

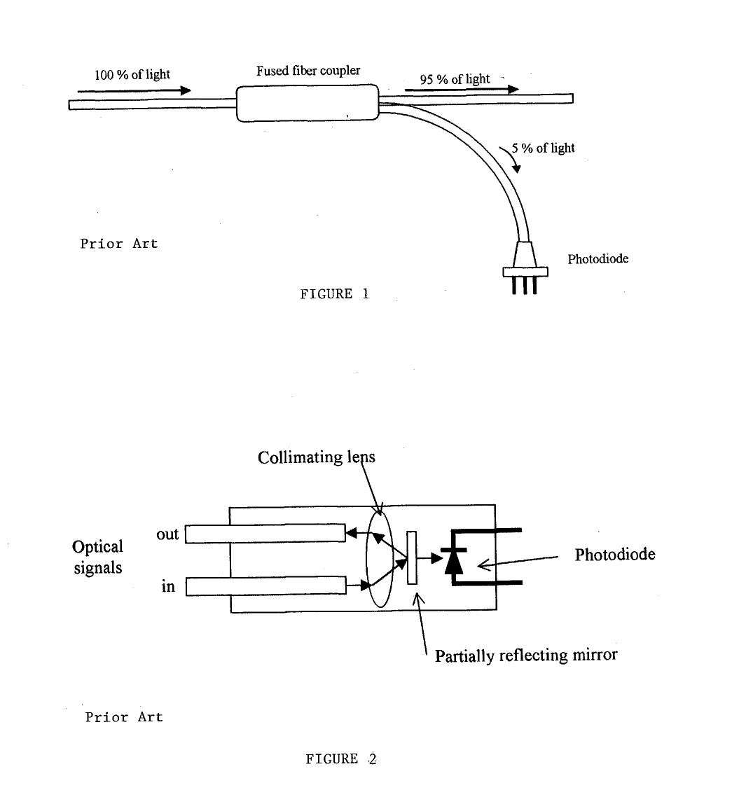

### DETAILED DESCRIPTION OF THE INVENTION

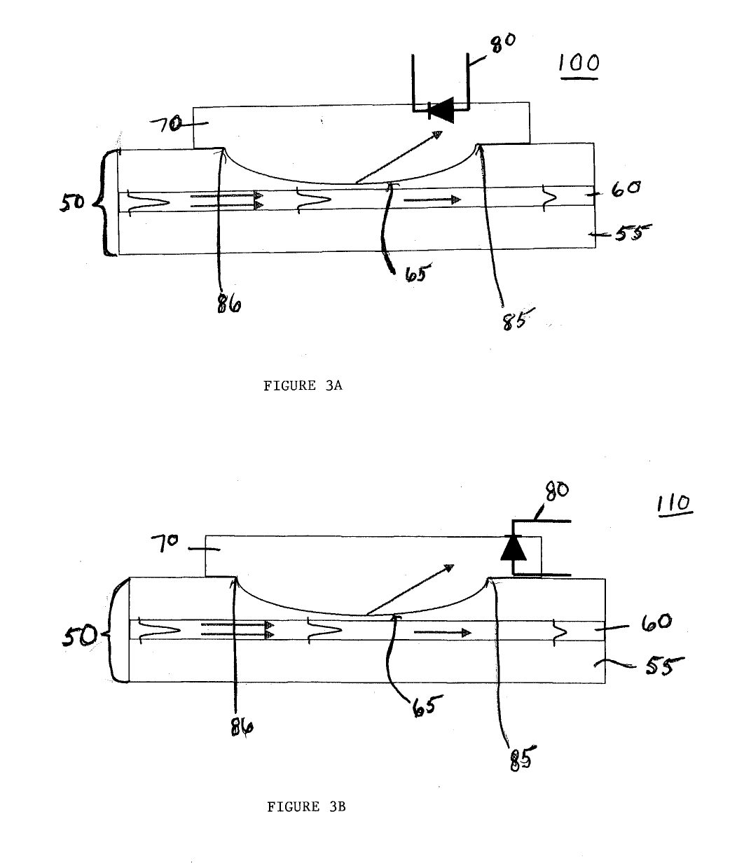

Therefore, in accordance with the principles of the present invention, FIGS. 3A and 3B depict directional integrated optical power monitors 100 and 110, respectively, in a first embodiment in which a single-mode optical fiber 50 (e.g., telecommunications Corning SMF-28) has been side-polished through its cladding 55 close to its core 60, thereby exposing an optical surface through side surface 65. Alternatively, in the power monitors of the present invention, a polarization maintaining fiber (e.g. Corning PureMode™ PM photonic fiber) may be used as fiber 50. The cladding thickness remaining after side-polishing the fiber to remove material from cladding 55 and exposing surface 65 is typically <10 μm. The evanescent field of an optical signal propagating through the fiber penetrates side surface 65. The signal is normally unaffected if the side surface 65 is coated by a substance having an index of refraction lower than that of the fiber cladding (e.g., air or water). However, in accordance with the present invention, when the exposed side surface is in contact with a substance having a higher refractive index, some of the signal will couple into it and can be extracted. The amount of optical energy flowing through the fiber can then be deduced based on the amount of light leaking from the side surface into the adjacent material, as measured by an optimally placed photodetector 80.

Thus, as shown in FIGS. 3A and 3B, a controlled percentage of optical energy can be extracted-from fiber core 60 and subsequently measured using photodector 80 via the application of bulk material 70 over exposed side polished surface 65 of the fiber cladding. The bulk material 70 should have a refractive index higher than that of the fiber's effective mode index n_{ef}. This value is dependent upon the fiber core and cladding indices, and the fiber core dimensions, but usually lies between the core and cladding indices. As will be explained herein, a photodetector 80 attached to bulk material 70 or to support block 45 (not provided in this embodiment) resides at the place of maximum optimal signal strength to capture the optical energy extracted from the side surface. From the intensity of the signal output from the photodetector, the strength of the optical signal in the optical fiber can be calculated.

Side-Polished Fiber

Standard single-mode fibers, e.g., Corning SMF-28 have an 8.3 μm diameter core region 60 of slightly raised refractive index surrounded by a 125±1 μm fused silica cladding 55. The mode field diameter is 9.3±0.5 μm at 1310 nm and 10.5±0.5 μm at 1550 nm. The refractive index values supplied by Corning for SMF-28 fiber are:

λ=1300nm:n_{core}=1.4541,n_{clad}=1.4483

λ=1550nm:n_{core}=1.4505,n_{clad}=1.4447

The small difference between the core and cladding refractive indices combined with the small core size results in single-mode propagation of optical energy with wavelengths above 1190 nm. Therefore, the fiber can be used in both spectral regions.

As previously mentioned, bulk material 70 should have a refractive index higher than that of the fiber's effective mode index n_{ef}. For Corning SMF-28 fiber, this value lies between the above-provided core and cladding indices. For Corning PureMode™ PM photonic fiber, n_{ef} is 1.47 at 1500 nm.

The side-polished fibers (SPF) for use in the optical monitors of the present invention are prepared using lapping and polishing techniques, such that the coupling strength of the resulting SPF ranges from about 1-20%. As used herein, the term “polishing coupling strength” refers to the amount of light removed in the polished region or side surface 65 of fiber 50, as measured using 1.6 refractive index oil, and the term “device coupling strength” refers to loss of light in the polished region 65 after completion of the device (i.e., after the bulk material and optional coupling material are applied atop the side surface or polished region 65). In some embodiments, as described below, the “polishing coupling strength” lies in the range of 1-10%, and in others, in the range of about 1-20%. In the latter case, an initial high polishing coupling strength is sometimes necessary to obtain a device coupling strength lying in the range of 1-10% coupling strength.

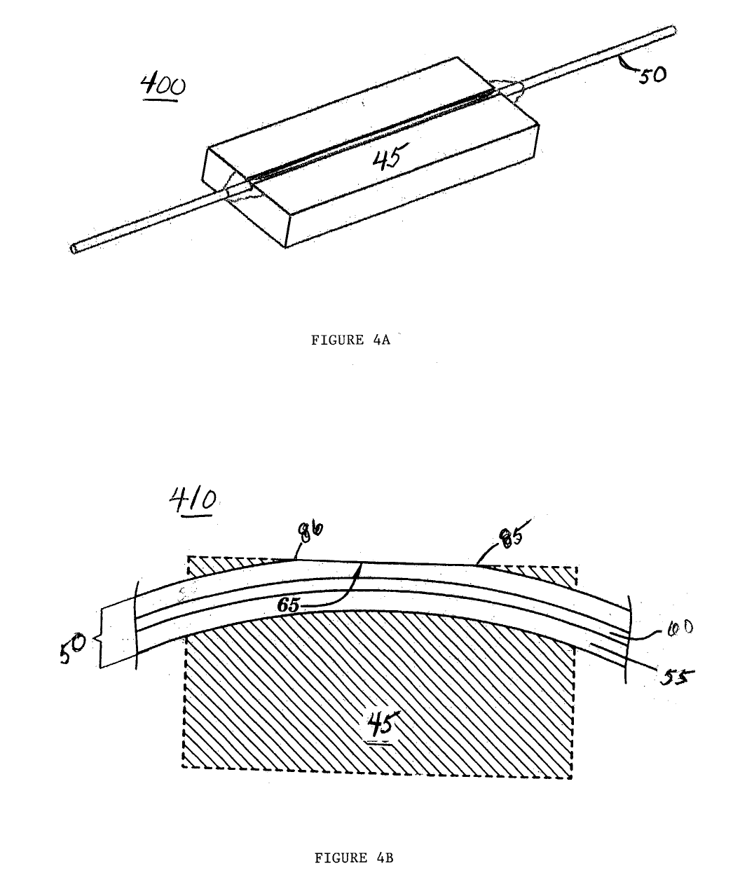

Prior to polishing, as depicted in FIG. 4B, which is a perspective view of a structure 400, the fiber 50 is typically embedded in a support block 45 of solid material to aid in handling and packaging of the device. The dimensions of a typical support block are about 4 mm wide×4 mm height×20 mm length, although blocks of other sizes may be used. The fiber 50 is set into support block 45 in a groove having a controlled radius ranging from 2 cm to 100 cm, but typically with a 7.7 cm radius. Exemplary block materials include glass (fused silica) and metals, such as Kovar (alloy of iron, cobalt, and nickel with an expansivity similar to that of glass), Invar (low thermal expansion steel alloy), or a stainless steel alloy. Kovar and Invar are commercially available from Ed Fagin, Inc., Franklin Lakes, New Jersey.

FIG. 4b is a cross-sectional view showing structure 410, which is support block 45 and fiber 50 after it has been side-polished. Briefly, material is carefully removed from the fiber cladding 55 until core 60 is approached. When part of the cladding is removed, a new cladding exists which is composed of a small thickness of fused silica surrounded by air (n=1). At this point, the evanescent field of the optical energy transmitted in the optical fiber can be accessed through side surface 65. The device interaction length can be controlled by the remaining cladding thickness and the groove's radius of curvature. The polishing process continues until a predetermined amount of light is coupled out of the fiber when, for example, a liquid overlay, such as, for example, a polymer or an oil with an index (n_{d} at the sodium D line wavelength (λ=589 nm)) of 1.6 or greater is applied. As mentioned above, a coupling strength ranging from 1-20% is desirable in the present invention. Dispersion equations are available which allow the response to be adjusted to the spectral region of interest i.e. 1300 nm or 1550 nm. Transmission measurements can be made using Fabry-Perot Diode Lasers at 1300 nm and 1550 nm and a well-calibrated Optical Power Meter. Stronger attenuation figures are observed for the same liquid index at 1550 nm since the evanescent penetration of the fiber mode field into the cladding is greater at the longer wavelength.

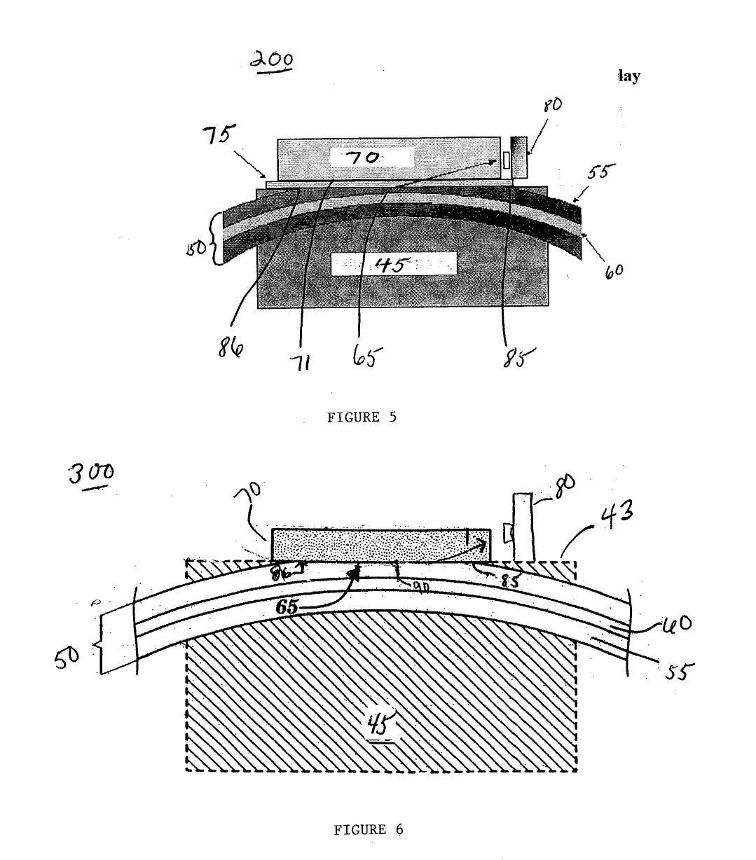

After polishing is complete, side surface 65 terminates at two ends: a first end, 85, and a second end, 86, both residing along the portion of the optical fiber. At this time, fiber 50 can be removed from support block 45, as shown in FIGS. 3A and 3B, and suspended from two support points of a fiber support structure (not shown), as described in commonly assigned U.S. Pat. No. 6,205,280. Alternatively, after polishing, fiber 50 can remain supported by support block 45, as shown in FIG. 5. When the optical power monitor of the present invention depicted is fabricated using support block 45 as part of the device, the portion of the optical fiber which is sidepolished is secured to the block prior to polishing. When the block is glass, an organic material, such as an epoxy is often used to adhere the fiber to the block. This procedure is described in commonly assigned U.S. Pat. No. 5,966,493. However, in applications where organic materials are undesirable in the optical power monitor, the fiber can be bonded to a metal block using a low-melting temperature glass solder, such as manufactured and sold by Diemat (Topsfield, Mass.). This procedure is described in detail in copending, commonly assigned U.S. Provisional Patent Application entitled “Side-Polished Fiber in Metal Block”, which was filed on Mar. 6, 2003.

Bulk Material

In accordance with the present invention, bulk material 70 is applied over exposed side surface 65 of the side-polished fiber optic. Bulk material 70 should be a material having an index of refraction, n_{d}, greater than the effective mode index of the optical fiber. Thus, when SMF-28 is used as the optical fiber, a bulk material having an index of refraction greater than 1.46 is desirable, but more preferably greater than 1.5. When Pure Mode™ PM photonic fiber is used, the index of refraction of the bulk material should be greater than 1.47. This allows the percentage of signal from the optical fiber leaking into the bulk material through the polished area (i.e. side surface) to be monitored using a photodetector, as described below.

Bulk material 70 should exhibit a stable index of refraction over a changing temperature. Exemplary bulk materials 70 include glass and organic polymers, such as high index optical epoxies. An organic polymer is shown in FIGS. 3A and 3B as bulk material 70. Suitable polymers include epoxies, such as Norland Optical Adhesive 68 (n_{d}=1.54) and Norland Optical Adhesive 63 (n_{d}=1.56), which are available from Norland Products, Inc., Cranbury, N.J. Other useful epoxies include Optodyne UV-3100 and Optodyne UV-3200, which are available from Daikin Industries, LTD, Osaka, Japan. However, the invention is not limited to the use of these materials, and other suitable epoxies and polymers having refractive indices higher than the effective mode index of the optical fiber could be used, as would be obvious to those of skill in the art. When bulk material 70 is a high index polymer or epoxy, it can be placed directly atop polished side surface 65 to a thickness ranging from about 0.5 to 10 mm, but preferably greater than 2 mm.

Alternatively, solid glass can be used as bulk material 70, as shown in FIG. 5, which is a cross-sectional view of directional integrated optical power monitor 200 of the present invention. In this embodiment, fiber 50 remains supported in support block 45, and the bottom optical surface 71 of glass overlay 70 is mounted over side surface 65. One advantage of using glass as the bulk material instead of a polymer is that the temperature stability of the resulting device is better with glass. One suitable glass for use as overlay 70 is Schott Borofloat (refractive index, n_{d}=1.472), which is commercially available from Bes Optics, Inc. of W. Warwick, R.I. Another suitable glass overlay is Schott BK-10, Schott Corporation, Technical Glass Division, New York. BK-10 glass has an index of refraction of n_{d}=1.497. In general, the glass overlay bulk material 70 is a slab of material (e.g. 1.5 mm wide×1.5 mm high×10 mm length), which aligns with the axis of polished fiber 50. Of course, glass overlays of other dimensions could be used, as would be obvious to one of skill in the art.

When a glass overlay is used as bulk material 70, support block 45 of FIG. 5 can be made of fused silica glass, Kovar, Invar, or a stainless steel alloy. When silica glass is used as block 45, optical fiber 50 of optical power monitor 200 is polished to a coupling strength ranging from 1-10%, but preferably about 5%. Prior to positioning the optical surface 71 of glass 70 over exposed side surface 65 of the fiber, a bonding material or coupling agent 75 (such as a polymer, an epoxy, a ceramic or some other type of fluid or adhesive), which has a refractive index approximately matching that of the core, preferably +/−0.2 refractive index units of the core, is disposed atop side surface 65. Thus, in optical power monitor 200, the coupling agent 75 lies between the glass overlay 70 and the exposed side surface 65 of the fiber 50. Suitable bonding materials and coupling agents 75 include Optodyne UV-1100 (Daikin Industries, LTD) having a refractive index of 1.435 and optical grade epoxy 353ND (n_{d}=1.58), which has good thermal stability. Epoxy 353ND is available from Epoxy Technology, Inc., Billerica, Mass. When using epoxy or other coupling agent to secure the overlay 70 to the block, it is important to have only a very thin layer (1-10 microns) of epoxy (or other coupling agent) between the overlay and the polished fiber, so that the temperature dependence of the refractive index of the coupling agent has minimal effect on the transmission of the optical signal through the fiber. Note, however, that a fillet of epoxy having a thickness ranging from 30 to 100 microns may form around the perimeter of the overlay.

In an alternative embodiment using glass as bulk material 70, which is shown as device 300 in FIG. 6, support block 45 used in connection with optical power monitor 300 comprises a metal, such as Invar, Kovar, or a stainless steel alloy. The advantage of using a metal block is that the fiber can be secured to the block, and the glass overlay can be affixed over side surface 65 without the use of epoxies, polymers, ceramics, organic adhesives, or other organic coupling agents. In some applications, the use of these materials is undesirable because they tend to alter the index of refraction of the monitor's components. Prior to placing the glass slab overlay 70 over side surface 65, the fiber is polished to a coupling strength ranging from about 1-20% so that the final coupling strength after welding (as described below) is in the range of 1-10%.

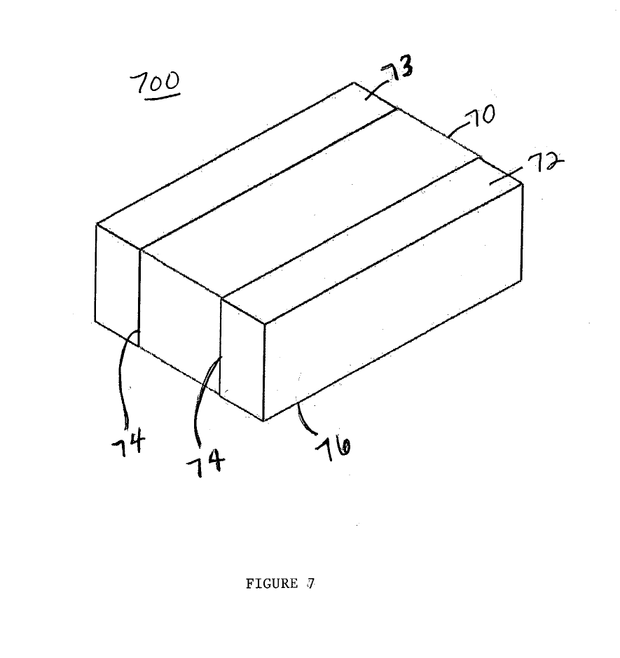

When support block 45 is metal, metal brackets may be bonded to the opposing sidewalls of the glass to form an overlay comprising glass and metal. FIG. 7 shows a perspective view of such an overlay 700, which is used in the device of FIG. 6. A first metal bracket 72 is bonded to a first sidewall (not shown) of glass overlay 70, and a second metal bracket 73 is bonded to the opposing second sidewall (no shown) of glass 70. Metal brackets 72 and 73 may be bonded to glass 70 using a low temperature glass solder, such as Diemat material. Alternatively, conventional sealing glasses, such as Corning 7056, that melt at higher temperatures (720° C.) can be used to bond the overlay glass to the brackets. A glass solder bond line 74 resides between each metal bracket 72 and 73 and each sidewall of glass overlay 70. After aligning the glass over the SPF, the bottom surfaces 76 of the attached metal brackets 72 and 73 are welded or soldered to the top surface 43 (see FIG. 6) of the underlying metal support block 45. Welding provides a bond that is stronger and more stable than that obtained using an epoxy. However, the bottom optical surface of the glass overlay remains free of welding/soldering to either the metal support block or metal brackets, and the optical surface of the glass overlay is positioned over the side surface of the optical fiber. A YAG laser welder may be used to weld the metals together.

Optionally, after welding the overlay in place, a coupling agent, such as an optical grade epoxy with good thermal stability, e.g., 353ND (n_{d}=1.58) from Epoxy Technology, Inc. can be wicked into the very thin space 90 between overlay 70 and exposed side surface 65 of the fiber (see FIG. 6). The purpose of the epoxy is to replace the air in the space 90 with a higher index material, which then improves the coupling strength, i.e. increases the amount of light passing into the overlay. Subsequent curing of the epoxy preserves the good coupling. As mentioned above, only a very thin layer (1-10 microns) of epoxy (or other coupling agent) should be wept in space 90 between the overlay 70 and the polished fiber 65. Furthermore, the coupling agent should have an index of refraction approximately matching that of the core (+/−0.2 refractive index units of the core).

Alignment and Positioning of the Photodetector

In fabricating the power monitors described herein and depicted in the drawings, a photodetector 80 is positioned in close proximity to one end 85 of the fiber's exposed side surface 65 to capture the escaped optical signal. From the intensity of the signal output measured by the photodetector 80, the strength of the optical signal in the optical fiber can be deduced.

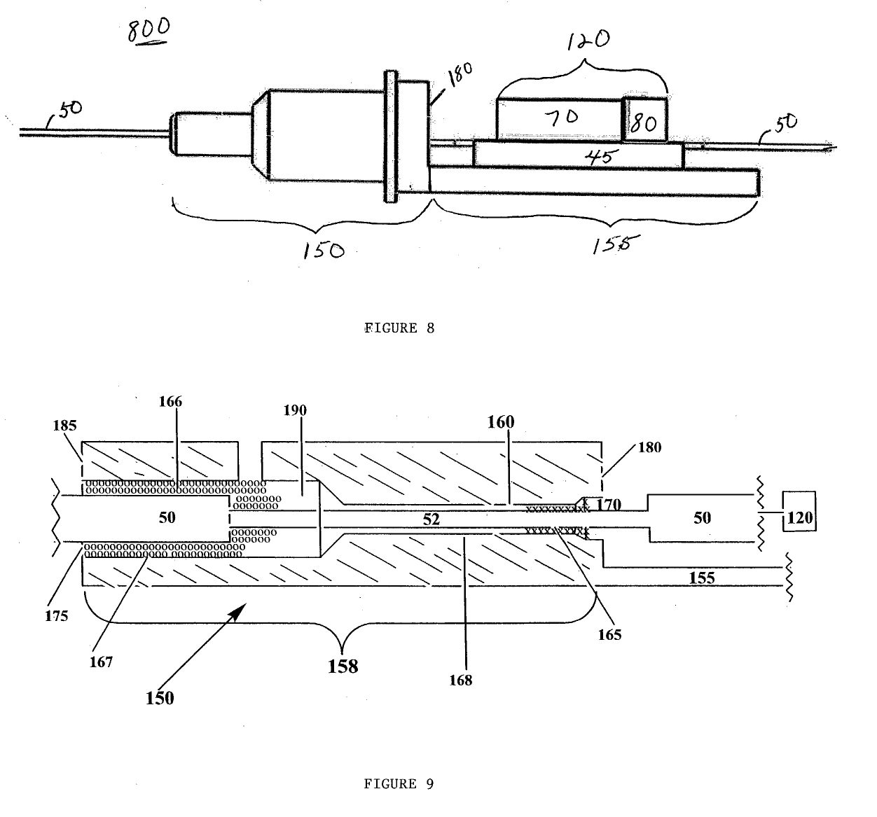

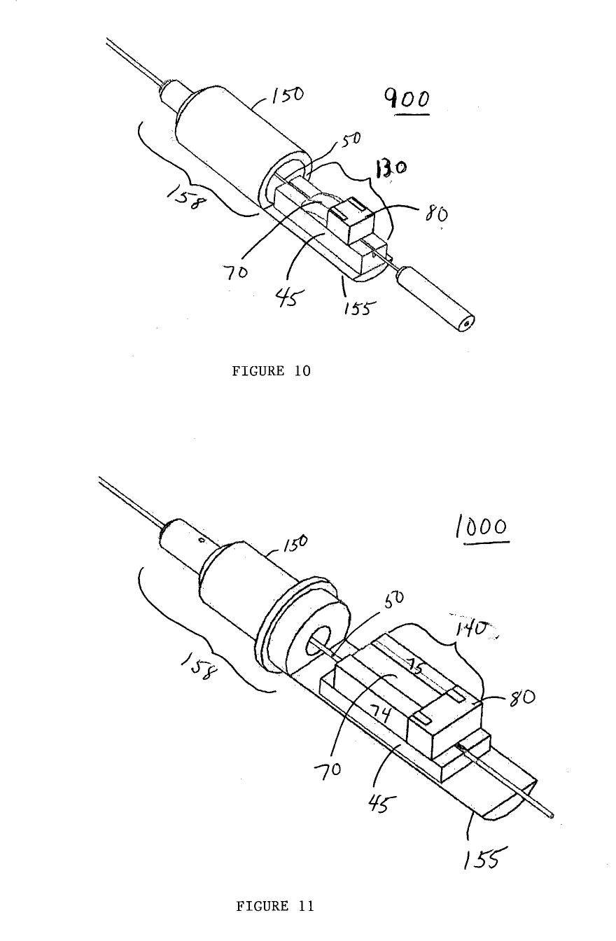

The photodetector 80 should be secured to the device at the place of maximum optical signal strength. When bulk material 70 is a polymer, photodetector 80 can either be placed in the polymer, as shown in FIGS. 3A and 3B or beside it and mounted to support block 45, as shown in FIG. 8. When bulk material 70 is a glass overlay, photodetector 80 can be mounted to support block 45 or can be attached to the end face of the glass overlay, as depicted in FIGS. 5 and 10 via epoxy or solder.

To determine the position of maximum optical signal strength, the photodetector 80 can be actively aligned (moved) after the bulk material 70 has been placed atop the exposed side surface 65 of the fiber. One end of the fiber can be connected to a light source and the photocurrent generated by the photodetector can be measured. The optimal position of the photodetector is the position that gives maximum photo-current. After actively aligning the photodetector, the photodetector can then be secured into place at this position, either to the support block or into the polymer. However, when the photodetector is pre-mounted to the end face of the glass overlay, the glass overlay can be actively aligned to maximize the photodetector sensitivity, then welded or soldered in place when metal brackets are used, or bonded in place by curing the epoxy when an epoxy is used to secure the glass.

Integrated Optical Power Monitor and Hermetic Feedthrough

As previously mentioned, it is advantageous to combine functions in single assemblies. To accomplish this, the present directional integrated optical power monitor can be combined with a hermetically sealable fiber feedthrough, resulting in a device that is more compact and economical than anything currently available using existing technology.

A side-view of this embodiment is depicted as assembly 800 in FIG. 8. Power monitor 120, which includes SPF support block 45, is mounted on a platform 155, which extends from a first end 180 of metal ferrule 150. Metal ferrule 150 and platform 155 are typically made of Kovar, Invar, or a stainless steel alloy. The ferrule may optionally be plated with gold. The SPF block 45 is attached to ferrule platform 155 typically by solder, welding or epoxy. Fiber 50, which includes a protective buffer material cover or sheath, such as an acrylate, over the cladding, extends from optical power monitor 120 to ferrule 150.

FIG. 9 is a cross-sectional view of the conventional metal ferrule 150 of FIG. 8, which shows optical fiber feedthrough hole 158. Metal ferrule 150 has a first end 180 with a first opening 170, which opens into a first cavity 160 and has a second end 185 with a second opening 175, which opens into a second cavity 190. The first cavity 160 of the ferrule is in fluidic communication with the second cavity 190 thereby forming feed-through hole 158, which extends from the first opening 170 to the second opening 175. Typically, the first cavity 160 and the second cavity 190 are substantially concentric. Prior to entering first opening 170 of ferrule 150, the buffer material is stripped from the portion of fiber 50 extending from power monitor 120, forming a section of bare optical fiber 52. This bare fiber 52, which is free of the protective cover, enters the small inner diameter of first cavity 160 through first opening 170, then passes through first cavity 160 and into second cavity 190. The bare optical fiber 52 is positioned within first cavity 160 and second cavity 190. In second cavity 190, optical fiber 50 having buffer material thereon extends from bare fiber 52 and is positioned within the second cavity, where it exits through second opening 175. Thus, the fiber originating from the integrated optical monitor 120 enters and exits the ferrule, passing through feedthrough hole 158.

At the small outer diameter of first opening 170 of the ferrule, the bare fiber 52 is glass sealed to the ferrule with a low temperature glass solder material, such as Diemat, forming a hermetic seal. The glass solder material 165 (depicted as x's in the drawing) adheres to and surrounds bare optical fiber 52 and also adheres to the interior wall 168 of first cavity 160. A high temperature, high strength, low CTE, low stress epoxy 166, depicted as o's in the drawing, is then placed in second opening 175 into second cavity 190. The epoxy adheres to an interior wall 167 bordering the second cavity of ferrule 150 and also contacts and adheres to the bare section 52 of the optical fiber. Suitable epoxies include TRA-BOND, BAF-114, and BAF-113SC, which are available from TRA-CON, Inc., Bedford, Mass. Other suitable epoxies include EPO-TEK 353ND, which is available from Epoxy Technology, Inc., Billerica, Mass.; and LCA 49/BA-501730, which is available from Bacon Industries, Watertown, Mass. Note that these epoxies are also suitable for bonding the support block to the ferrule, for bonding the photodetector to the glass overlay or to the support block, and for bonding the fiber to the support block. The process for fabricating a hermetically sealed feedthrough having high pull strength is disclosed in detail in commonly assigned U.S. Patent Application Serial No.: 60/429,084, filed Nov. 26, 2002.

FIG. 10 is a perspective view of an optical power monitor assembly 900 comprising integrated optical power monitor 130, which uses a polymer as bulk material 70 on support block 45 in combination with ferrule 150, such that optical fiber 50 is soldered hermetically to ferrule 150, as described above, to form a fiber feedthrough 158. The SPF support block 45, which can be made of glass, Kovar, Invar, or a stainless steel alloy, is mounted on a platform 155 extending from ferrule 150. The platform 155 supports block 45 in the assembly. The ferrule 150 and platform 155 are preferably made of Kovar, Invar, or a stainless steel alloy. The SPF block 45 is attached to the ferrule platform 155 by solder, welding or epoxy. Photodetector 80 is mounted to support block 45 via epoxy, solder, or welding.

FIG. 11 is a perspective view of an optical power monitor assembly 1000 comprising integrated optical power monitor 140 in combination with ferrule 150, and optical fiber 50 is soldered hermetically to ferrule 150, as described above, to form a fiber feedthrough 158. Integrated optical power monitor 130 uses a glass overlay as bulk material 70, and the glass overlay has metal brackets 74 and 75 bonded thereto, as previously described. The metal/glass overlay is mounted on support block 45, which is mounted on a platform 155 extending from ferrule 150. The platform 155 supports block 45 in the assembly. The ferrule 150, platform 155, and block 45 are preferably made of Kovar, Invar, or a stainless steel alloy. The SPF block 45 is attached to the ferrule platform 155 by solder, welding, or epoxy. Photodetector 80 is mounted to the end face of the glass/metal overlay via solder, welding, or epoxy.

Consideration will now be given to the following examples. It should be noted that the embodiments included and described herein are for illustrative purposes only, and the invention is in no way limited to the embodiments used in the examples. The photodetector used in the examples was an InGaAs pin detector having a 500 micron diameter and active area and purchased from Germanium Power Devices Optoelectronics Corporation, Salem, N.H.

### EXAMPLE 1

A SMF-28 fiber was mounted on a glass (fused silica) block (4 mm wide×4 mm height×20 mm length) and was polished to 5% coupling strength. The fiber was then removed from the block and suspended from two support points. A UV curable epoxy (Norland Optical Adhesive 68 with n_{d}=1.54) was then applied atop the exposed side surface of the fiber. The photodiode was placed in the polymer about 0.5 mm away from the center of the side surface of the polished fiber. The active area of the photodiode, which was about 2 to 3 mm away from side surface of the center of the polished area, was positioned parallel to the fiber axis. The optimal relative position of the fiber and photodiode was determined by connecting one end of the fiber to a light source, then moving the photodiode laterally across the polymer while measuring the photocurrent generated by the photodiode. The optimal position of the photodiode was the position that gave maximum photo-current. After the optimal position was found, the UV curable polymer was cured, resulting in the fabrication of the directional integrated optical power monitor depicted in FIG. 3A.

### EXAMPLE 2

The procedure of Example 1 was followed except that the active area of the photodiode was positioned perpendicular to the fiber axis. A directional integrated optical power monitor was formed, such as the one shown in FIG. 3B.

### EXAMPLE 3

A SMF-28 fiber was mounted on and secured to a fused silica block (4 mm wide×4 mm height×20 mm length) using epoxy. The fiber was polished to 5% coupling strength. A glass overlay comprising a piece of BK-10 glass (1.5×1.5×10 mm) with a refractive index of n_{d}=1.497 was used as the bulk material to extract light from the exposed side surface. Glued at the end face of the glass overlay was the InGaAs pin detector. The glass overlay/photodiode assembly was placed on top of the SPF block using a low index UV epoxy, i.e., Optodyne UV-1100 (n_{d}=1.435) to bond the overlay. The epoxy was positioned between the overlay and the side surface of the fiber. The optimal position of the glass overlay was then determined by finding the position that gave the maximum photo-current. After the optimal position was found, the assembly was fixed by curing the UV epoxy. This directional integrated optical power monitor is depicted in FIG. 5.

### EXAMPLE 4

A polarization maintaining fiber (Corning PureMode™ PM Photonic Fiber) was mounted on and secured to a glass (fused silica) block (4 mm wide×4 mm height×20 mm length). The fiber was polished to 5% coupling strength. A glass overlay comprising a piece of BK-10 glass (1.5×l.5×10 mm) with a refractive index of n_{d}=1.497 was used as the bulk material to extract light from the exposed side surface. Glued at the end face of the glass overlay was the InGaAs pin detector. The glass overlay/photodiode assembly was placed on top of the PM-SPF block using a low index UV epoxy, i.e., Optodyne UV-1100 (n_{d}=1.435) to bond the overlay. The epoxy was positioned between the overlay and the side surface of the PM fiber. The optimal position of the glass overlay was then determined by finding the position that gave the maximum photo-current. After the optimal position was found, the assembly was fixed by curing the UV epoxy. This directional integrated optical power monitor is depicted in FIG. 5.

### EXAMPLE 5

A SMF-28 fiber is mounted on and secured to a (glass) fused silica block (4 mm wide×4 mm height×20 mm length) using epoxy. The fiber is polished to between 1-5% coupling strength. The glass support block is attached with an epoxy to the platform of a Kovar ferrule. Fiber extending from the block is inserted through the small internal diameter of one end of the ferrule, passing through the feed-through and exiting from the second end of the ferrule. The fiber is stripped of its acrylate buffer material where it passes into the opening of the ferrule. At the small outer diameter opening at the first end of the ferrule, the fiber is glass sealed to the ferrule using Diemat as a low temperature glass solder and forming a hermetic seal. A high index UV curable polymer (Norland Optical Adhesive 68 with n_{d}=1.54) is applied atop the exposed side surface of the fiber as the bulk material to extract light from the exposed side surface. The photodiode is placed on top of the SPF block. The optimal position of the photodiode is determined by finding the position that gives the maximum photo-current. After the optimal position is found, the assembly is fixed by curing the UV epoxy and securing the photodiode to the block with epoxy. This integrated optical power monitor and hermetic feed-through assembly is depicted in FIG. 10.

### EXAMPLE 6

A SMF-28 fiber was mounted on and bonded to an Invar metal block (4 mm wide×4 mm height×20 mm length) using glass solder (Diemat). The fiber was polished to about 17% coupling strength. The bulk material was a glass overlay having metal brackets bonded to its sidewalls, which was prepared using Schott borofloat glass. The borofloat glass was bonded to welding brackets using Diemat glass solder. The photodiode is bonded to the endface of the glass/metal overlay. The overlay is actively aligned by monitoring the signal of 1550 nm light through the fiber. At the point of maximum photocurrent, the welding brackets are welded to the Invar block using a YAG laser welder. The Invar support block is welded to the platform of a Kovar ferrule. Fiber extending from the block of the power monitor is inserted through the small internal diameter of one end of the ferrule, passing through the feed-through and exiting from the second end of the ferrule. The fiber is stripped of its acrylate buffer material where it passes into the opening of the ferrule. At the small outer diameter opening at the first end of the ferrule, the fiber is glass sealed to the ferrule using Diemat as a low temperature glass solder and forming a hermetic seal. This integrated optical power monitor and hermetic feed-through assembly is depicted in FIG. 11.

### EXAMPLE 7

The integrated optical power monitor and hermetic feed-through assembly of Example 6 is fabricated, and 353ND epoxy is then wept into the thin gap between the borofloat overlay and the side polished fiber.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

All the patents and patent applications referred to herein are hereby incorporated herein in their entireties.

What is claimed is:

1. A directional integrated optical power monitor comprising:
(a) an unbroken portion of an optical fiber through which optical energy can propagate, said optical fiber having a core surrounded by a cladding, wherein said portion has material removed from said cladding thereby exposing a side surface through which at least some of said optical energy can be extracted, wherein said side surface terminates at a first end and a second end along said portion;
(b) a bulk material residing over said side surface, wherein said bulk material has an index of refraction higher than the effective mode index of refraction of said optical fiber; and
(c) a photodetector to capture said extracted optical energy, said photodetector being positioned at the place of maximum optical signal strength, said place being in close proximity to said first end or said second end of said side surface.

2. The power monitor of claim 1, wherein said bulk material is a polymer.

3. The power monitor of claim 2, wherein said photodetector is mounted in said polymer.

4. The power monitor of claim 1 further comprising a support block to which said portion of said optical fiber is secured, wherein said support block is selected from the group consisting of glass and metal, wherein said metal is Invar, Kovar, or a stainless steel metal alloy, and wherein said bulk material comprises a polymer or a glass overlay, said glass overlay having an optical surface positioned over said side surface.

5. The power monitor of claim 4, wherein said bulk material is a polymer and said photodetector is mounted in said polymer or to said support block.

6. The power monitor of claim 4, wherein said bulk material comprises a glass overlay, said support block is glass, and said power monitor further comprises a coupling agent disposed between said side surface and said optical surface of said glass overlay, wherein said coupling agent has an index of refraction approximately matching the index of refraction of the core of said optical fiber.

7. The power monitor of claim 6, wherein said photodetector is mounted to an end face of said glass overlay or to said support block.

8. The power monitor of claim 4, wherein said support block is a metal, and said bulk material comprises a glass overlay having a first and second metal bracket bonded thereto, wherein said first metal bracket is bonded to a first sidewall of said glass overlay, and said second metal bracket is bonded to a second sidewall of said glass overlay, each said metal bracket being bonded to a top surface of said metal support block, and said optical surface of said glass overlay being positioned over said side surface.

9. The power monitor of claim 8, wherein said photodetector is mounted to an end face of said glass overlay or to said support block.

10. The power monitor of claim 9 further comprising a coupling agent disposed between said side surface of said fiber and said optical surface of said glass overlay, wherein said coupling agent has an index of refraction approximately matching the index of refraction of the core of said optical fiber.

11. An optical power monitor assembly comprising said directional integrated optical power monitor of claim 4 in combination with a hermetic feedthrough, wherein said assembly comprises:
(a) a metal ferrule having a first end with a first opening, which opens into a first cavity in said ferrule, and having a second end with a second opening, which opens into a second cavity in said ferrule, said first cavity being in fluidic communication with said second cavity thereby forming a feedthrough hole, which extends from said first opening to said second opening;
(b) a metal platform extending from said first end of said metal ferrule and supporting said directional integrated optical power monitor;
(c) a section of bare optical fiber extending from said portion of optical fiber of said directional integrated optical power monitor, wherein said bare optical fiber is free of a protective buffer material cover, wherein said section of bare optical fiber enters said first cavity through said first opening of said ferrule, passing through said first cavity and into said second cavity;
(d) a section of optical fiber having said protective buffer material cover thereon extending from said bare optical fiber in said second cavity and exiting said ferrule through said second opening; and
(e) a glass solder material disposed in said first opening and residing in said first cavity, wherein said glass solder material adheres to and surrounds said bare optical fiber and adheres to an interior wall bordering said first cavity of said ferrule, to form a hermetic seal at said first opening.

12. The optical power monitor assembly of claim 11, wherein said bulk material of said directional integrated optical power monitor is a polymer, and said photodetector is mounted in said polymer or to said support block.

13. The optical power monitor assembly of claim 11, wherein said bulk material of said directional integrated optical power monitor comprises a glass overlay, said support block is glass, and wherein a coupling agent is disposed between said side surface of said portion of said optical fiber and said optical surface of said glass overlay, wherein said coupling agent has an index of refraction approximately matching the index of refraction of the core of said optical fiber, and wherein said photodetector is mounted to an end face of said glass overlay or to said support block.

14. The optical power monitor assembly of claim 11, wherein said support block of said directional integrated optical power monitor is a metal, and said bulk material comprises a glass overlay having a first and second metal bracket bonded thereto, wherein said first metal bracket is bonded to a first sidewall of said glass overlay, and said second metal bracket is bonded to a second sidewall of said glass overlay, each said metal bracket being bonded to a top surface of said metal support block, and wherein said optical surface of said glass overlay is positioned over said side surface, and wherein said photodetector is mounted to an end face of said glass overlay or to said support block.

15. The optical power monitor assembly of claim 14, wherein said directional integrated optical power monitor further comprises a coupling agent disposed between said side surface of said portion of said optical fiber and said optical surface of said glass overlay, wherein said coupling agent has an index of refraction approximately matching the index of refraction of the core of said optical fiber.

16. The optical power monitor assembly of claim 11, further comprising:
(f) an epoxy material extending from said second opening into said first cavity, wherein said epoxy material adheres to an interior wall bordering the second cavity of said ferrule and also contacts and adheres to said section of bare optical fiber.
